(19) United States
(12) Patent Application Publication
(10) Pub. No.: US 2023/0142503 A1
(43) Pub. Date: May 11, 2023

(54) METHOD AND SYSTEM FOR DYNAMICALLY SWITCHING TRANSMISSION MODES TO DECREASE LATENCY IN UNLICENSED CONTROLLED ENVIRONMENTS

(71) Applicant: INSTITUTE FOR INFORMATION INDUSTRY, Taipei City (TW)

(72) Inventor: Kun-Hung LEE, Taipei City (TW)

(21) Appl. No.: 17/535,954

(22) Filed: Nov. 26, 2021

(30) Foreign Application Priority Data
Nov. 10, 2021 (TW) 110141738

(51) Int. Cl. H04L 1/00; H04L 5/00

(52) U.S. Cl. CPC H04L 1/0018; H04L 5/0055

(57) ABSTRACT

The present disclosure is a method and a system for dynamically switching transmission modes to decrease latency in unlicensed controlled environments (UCEs). The system includes a user equipment (UE) to execute the method. When a next generation Node B (gNB) successfully receives data transmitted by the UE, the UE will start a configured grant (CG) timer and count a CG counter, and the UE will calculate a CG weight. The UE further determines communication quality between the UE and the gNB according to the CG weight. When the CG weight is greater than a CG threshold, the UE determines that the communication quality is good, and the UE will switch to a first CG transmission mode to decrease latency for transmitting the data. Therefore, spectrum usage efficiency in the UCE can be improved.

### CROSS-REFERENCE TO RELATED APPLICATION(S)

This application claims the priority benefit of TW application serial No. 110141738 filed on Nov. 10, 2021, the entirety of which is hereby incorporated by reference herein and made a part of the specification.

### BACKGROUND

### 1. Field of the Disclosure

The present disclosure relates to a method and a system for switching transmission modes, in particular to a method and a system for dynamically switching transmission modes to decrease latency in unlicensed spectrum control environments (UCEs).

### 2. Description of the Prior Arts

In the fifth generation (5G) communication technology standard specifications, there are at least two transmission modes for a user equipment (UE) to transmit uplink radio signals to a next generation Node B (gNB). One of the transmission modes is the ultra-reliable and low latency communications configured grant mode (URLLC CG mode), and the other one of the transmission modes is the new radio unlicensed configured grant mode (NR-U CG mode).

URLLC CG mode is used in the licensed spectrum to solve the latency problem when the communication quality of the radio channels is good. The NR-U CG mode is used in the unlicensed spectrum to solve the reliability problem when the communication quality of the radio channels is bad.

However, the communication quality of the radio channels is constantly changing in unlicensed controlled environments (UCEs). For example, unpredictable noise interference often decreases the communication quality of the radio channels. When there is no noise interference, the radio channels can maintain good communication quality. Therefore, if only a single transmission mode is used, it is easy to cause excessive latency or poor transmission reliability.

For example, if the UE transmits uplink radio signals to the gNB by the NR-U CG mode and the communication quality of the radio channel is good without noise interference, the NR-U CG mode can maintain higher reliability but increase the latency.

Therefore, the existing transmission method for the UE to transmit the uplink radio signals to the gNB still needs to be further improved.

### SUMMARY

In view of the above problems, the present disclosure provides a method and a system for dynamically switching transmission modes to decrease latency in unlicensed spectrum control environments (UCEs). In environments where the communication quality of the radio channels may change, a user equipment (UE) automatically and dynamically switches the transmission modes of transmitting uplink radio signals to a next generation Node B (gNB) based on the communication quality of the radio channels, thereby improving spectrum usage efficiency in the UCEs.

The system for dynamically switching transmission modes in UCEs includes a UE, and the UE executes the method for dynamically switching transmission modes in UCEs. When the UE executes the method, the UE executes steps of: transmitting a new data to a gNB; determining whether the gNB successfully receives the new data; when the gNB successfully receives the new data, starting a CG timer, increasing a count value of a CG counter, resetting a failed transmission count value of a failed transmission counter, calculating a CG weight according to a timing value of the CG timer and the count value of the CG counter, and determining whether the CG weight is greater than or equal to a CG threshold; when the CG weight is greater than or equal to the CG threshold, switching to a first CG transmission mode; when the CG weight is smaller than the CG threshold, transmitting a next new data to the gNB.

The CG weight is calculated by the following formula:

$$W = a \times timer + b \times counter ;$$

$$timer = \frac{timer\_current}{timer\_max} ;$$

$$counter = \frac{counter\_current}{counter\_max} ;$$

W is the CG weight, a is a time weight, b is a count weight, timer_current is the timing value, timer_max is a preset maximum of waiting time, counter_current is the count value, counter_max is a maximum number of preset allowable success, and a+b=1.

The CG threshold is calculated by the following formula:

TH=MAX[a,b];

TH is the CG threshold.

When the gNB successfully receives the new data from the UE, it means that the UE successfully transmits the new data to the gNB. At this time, the UE starts the CG timer and increases the count value of the CG counter. The UE further determines whether the CG weight is greater than or equal to the CG threshold. When the CG weight is greater than or equal to the CG threshold, it means that the UE successfully transmits data to the gNB many times. Therefore, the communication quality of the current radio channels is determined to be good, which causes the UE to successfully send data to the gNB many times. Therefore, the UE switches to the first CG transmission mode, thereby improving the latency of data transmission by the first CG transmission mode.

For example, the first CG transmission mode may be a URLLC CG mode. Therefore, when the communication quality is good, the latency of data transmission can be improved by the first CG transmission mode.

In addition, since the UE calculates the CG weight according to the timing value of the CG timer and the count value of the CG counter, the CG weight can be dynamically adjusted with time or a number of successful transmission. In other words, the present disclosure dynamically adjusts weights of a counter and of a timer to achieve the benefit of automatically adjusting and switching the CG transmission modes according to environmental changes.

In summary, the present disclosure can dynamically and automatically switch the current CG transmission mode based on the communication quality of the radio channels. When the communication quality of the radio channels is good, the UE switches to the first CG transmission mode. In this way, when the communication quality is good, the first CG transmission mode can be used to improve the latency, thereby improving spectrum usage efficiency in UCEs.

### BRIEF DESCRIPTION OF THE DRAWINGS

FIG. 1 is a schematic flowchart of a method for dynamically switching transmission modes to decrease latency in unlicensed spectrum control environments (UCEs) of the present disclosure.

FIG. 2 is a schematic block diagram of a system for dynamically switching transmission modes to decrease latency in UCEs of the present disclosure.

FIG. 3 is a schematic flowchart of a communication quality determination procedure of the method for dynamically switching transmission modes to decrease latency in UCEs of the present disclosure.

### DETAILED DESCRIPTION

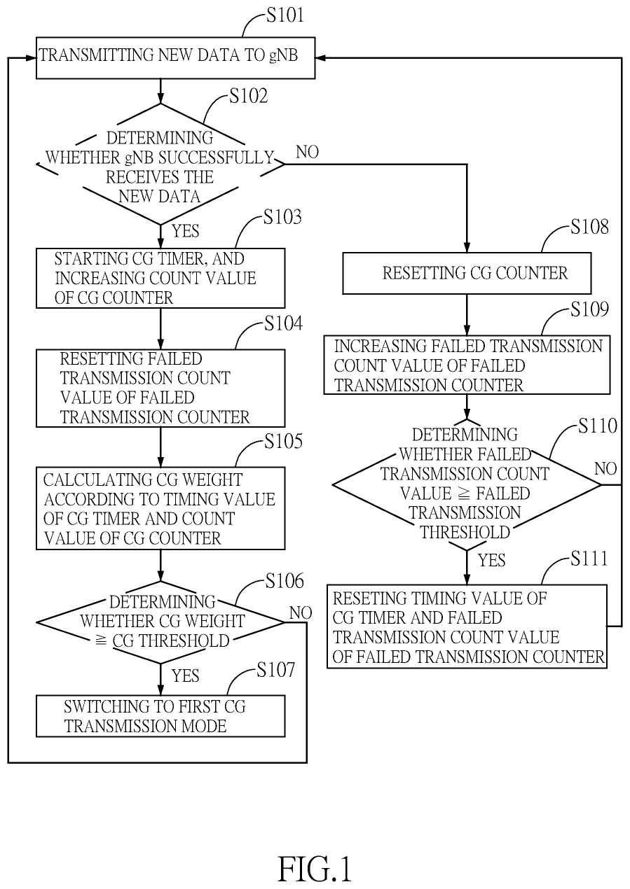

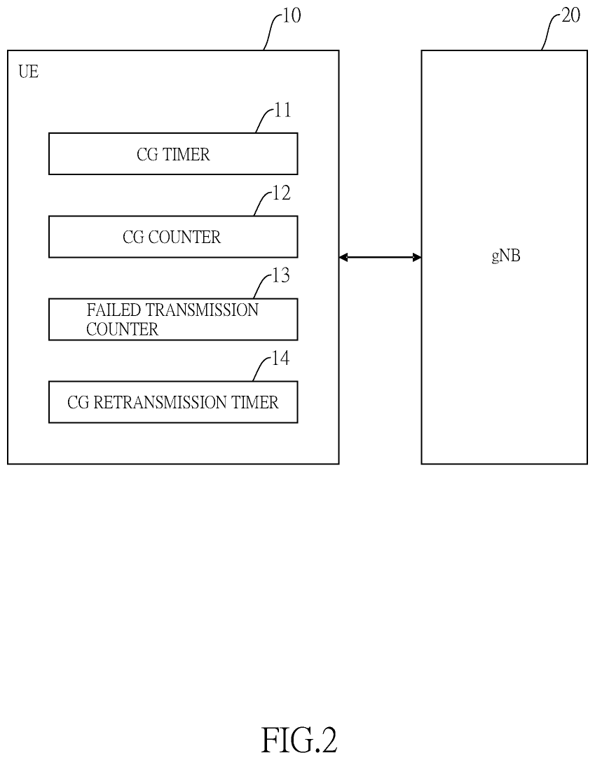

Referring to FIG. 1 and FIG. 2, a method for dynamically switching transmission modes to increase reliability in unlicensed spectrum control environments (UCEs) shown in FIG. 1 is executed by a user equipment (UE) 10 shown in FIG. 2. Please refer to FIG. 1 and FIG. 2 for the following description.

The method for dynamically switching transmission modes in UCEs is executed by the UE 10, and includes step S101 to step S111.

In step S101, the UE 10 transmits a new data to a next generation Node B (gNB) 20. For example, the new data may be uplink data. In the fifth generation (5G) communication technology standard specifications, the data transmitted by the UE 10 to the gNB 20 is uplink data, and the data transmitted by the gNB 20 to the user equipment 10 is downlink data.

In step S102, the UE 10 determines whether the gNB 20 successfully receives the new data. When the gNB 20 successfully receives the new data, it means that the UE 10 successfully transmits the new data to the gNB 20.

In an embodiment, the UE 10 determines whether the gNB 20 successfully receives the new data is determined by determining whether an acknowledgement (ACK) signal transmitted by the gNB 20 is received. When the UE 10 receives the ACK signal transmitted by the gNB 20, the UE 10 determines that the gNB 20 successfully receives the new data.

The gNB 20 will generate and transmit the ACK signal when the gNB 20 successfully receives and decodes the new data transmitted by the UE 10. Namely, when the UE 10 can receive the ACK signal from the gNB 20, it means that the gNB 20 successfully receives and decodes the new data.

In another embodiment, the UE 10 determines whether the gNB 20 successfully receives the new data by determining whether a negative-acknowledgement (NACK) signal transmitted by the gNB 20 is received. When the UE 10 receives the NACK signal transmitted by the gNB 20, the UE 10 determines that the gNB 20 unsuccessfully receives the new data.

The gNB 20 will generate and transmit the NACK signal when the gNB unsuccessfully receives or decodes the new data transmitted by the UE 10. Namely, when the UE 10 receives the NACK signal from the gNB 20, it means that the gNB 20 unsuccessfully receives or decodes the new data.

In still another embodiment, whether the gNB 20 successfully receives the new data is determined by determining whether a CG retransmission timer 14 expires. When the CG retransmission timer 14 expires, the UE 10 determines that the gNB 20 unsuccessfully receives the new data.

The CG retransmission timer 14 is used to determine whether the UE 10 receives the ACK signal within a preset time. Namely, when the UE 10 determines that the CG retransmission timer 14 expires, it means that the UE 10 does not receive the ACK signal within the preset time, and it also means that the UE 10 does not successfully transmit the new data.

In step S103, when the gNB 20 successfully receives the new data, the UE 10 starts a CG timer 11, and increases a count value of a CG counter 12. For example, the UE 10 starts the CG timer 11 and increases the count value of the CG counter 12 by one. In the embodiment, when the UE 10 determines that the gNB 20 successfully receives the new data at the first time, the UE 10 starts the CG timer 11, and increases the count value of the CG counter 12 by one from zero. When the UE 10 determines that the gNB 20 successfully receives the new data at the first time, since the CG timer 11 has been started, the UE 10 does not need to start the CG timer 11, and the UE 10 just needs to increase the count value of the CG counter 12 by one.

In step S104, the UE 10 resets a failed transmission count value of a failed transmission counter 13. When the UE 10 determines that the gNB 20 successfully receives the new data, the UE 10 can determine that the new data is successfully transmitted. Therefore, the UE 10 needs to reset the failed transmission count value of the failed transmission counter 13. Namely, the failed transmission count value means a number of continuously failed transmissions of data transmitted from the UE 10 to the gNB 20.

In step S105, the UE 10 calculates a CG weight according to the timing value of the CG timer 11 and the count value of the CG counter 12, and the CG weight is calculated by the following formula:

$$W = a \times timer + b \times counter ;$$

$$timer = \frac{timer\_current}{timer\_max} ;$$

$$counter = \frac{counter\_current}{counter\_max} .$$

W is the CG weight, a is a time weight, b is a count weight, timer_current is the timing value, timer_max is a preset maximum of waiting time, counter_current is the count value, counter_max is a maximum number of preset allowable success, and a+b=1. For example, the preset maximum of waiting time timer_max is a maximum of the timing value of the CG timer 12, and the maximum number of preset allowable success counter_max is a maximum of the count value of the CG counter 12. In this embodiment, the maximum of the timing value of the CG timer 12 is 200 milliseconds (ms), and the maximum of the count value of the CG counter 12 is ten.

In step S106, the UE 10 further determines whether the CG weight is greater than or equal to a CG threshold.

The CG threshold is calculated by the following formula:

TH=MAX[a,b];

TH is the CG threshold and equals to a maximum of the time weight a and the count weight b. For example, if a=0.7, b=0.3, since a>b, TH=a=0.7.

In step S107, when the CG weight is greater than or equal to the CG threshold, the UE 10 switches to the first CG transmission mode.

When the CG weight is smaller than the CG threshold, the UE 10 transmits a next new data to the gNB 20 (S101).

In the embodiment, a CG transmission mode between the UE 10 and the gNB 20 executed in the step S101 is the NR-U CG mode. After several steps in FIG. 1, in S107, the UE 10 is switched to the first CG transmission mode, wherein the first CG transmission mode is the URLLC CG mode.

In step S108, when the gNB 20 unsuccessfully receives the new data, the UE 10 resets the CG counter 12.

In step S109, the UE 10 increases the failed transmission count value.

In step S110, the UE 10 determines whether the failed transmission count value is greater than or equal to a failed transmission threshold.

In step S111, when the failed transmission count value is greater than or equal to the failed transmission threshold, the UE 10 resets the timing value of the CG timer 11 and the failed transmission count value of the failed transmission counter 13, and then the UE 10 transmits a next new data to the gNB 20 (S101).

Further, when the failed transmission count value is smaller than the failed transmission threshold, the UE 10 directly transmits the next new data to the gNB (S101).

The CG counter 12 of the UE 10 can count a number of UE successful transmissions, or a number of gNB successful receptions. When the UE 10 successfully transmits the new data or the gNB 20 successfully receives the new data, the UE 10 further determines the communication quality of radio channels according to the timing value of the CG timer 11. Namely, the UE 10 counts the number of the UE successful transmissions or the number of the gNB successful receptions within the preset maximum of waiting time (timer_max) according to the CG timer 11 and the CG counter 12.

For example, a1=0.7, b1=0.3, TH₁=0.7, timer_max=200 ms, counter_max=10. When the UE 10 determines that the gNB 20 successfully receives the new data after the UE 10 transmits a first new data to the gNB 20, the UE 10 starts the CG timer 11, and increases the counter value of the CG counter 12 by one. Since the UE 10 determines that the gNB 20 successfully receives the new data, the UE 10 resets the failed transmission count value of the failed transmission counter 13 to be zero. Then, the UE 10 calculates the CG weight according to the timing value of the CG timer 11 and the count value of the CG counter 12.

Since the CG timer 11 just begins to start timing, the timing value is zero. The CG counter 12 also begins to count, and the count value becomes one after the count value is increased. The CG weight is calculated by the following formula:

$$W = a \times timer + b \times counter = 0.7 \times \frac{0}{200} + 0.3 \times \frac{1}{10} = 0.03 ;$$

Since 0.03<0.7, the CG weight is smaller than the CG threshold. Therefore, the UE 10 transmits a second new data to the gNB 20.

If the UE 10 determines that the gNB 20 unsuccessfully receives the new data after the UE 10 transmits the second new data to the gNB 20, the UE 10 resets the count value of the CG counter 12 to be zero, and increases the failed transmission count value of the failed transmission counter 13 by one. Then, the UE 10 determines whether the failed transmission count value is greater than or equal to the failed transmission threshold.

The failed transmission counter 13 is increased by one when the UE 10 determines that the gNB 20 unsuccessfully receives the new data. When the UE 10 determines that the gNB 20 successfully receives the new data, the UE 10 will reset the failed transmission count value of the failed transmission counter 13. Therefore, when the gNB 20 has unsuccessfully received the multiple new data continuously, the failed transmission count value of the failed transmission counter 13 will be continuously accumulated. Namely, when the failed transmission count value of the failed transmission counter 13 is greater than the failed transmission threshold, it means that the gNB 20 has continuously and unsuccessfully received the multiple new data transmitted by the UE 10. Therefore, the UE 10 can determine the communication quality of the radio channels is bad, the UE 10 does not need to switch to the first CG transmission mode, and the UE 10 needs to maintain the current CG transmission mode for maintaining high reliability communications. The UE 10 further resets the CG timer 11 and the failed transmission counter 13 for avoiding switching to the first CG transmission mode.

However, after the UE 10 transmits the second new data to the gNB 20, if the UE 10 determines that the gNB 20 successfully receives the new data, the UE 10 further increases the count value of the CG counter 12 by one, and calculates the CG weight again. At this time, since the CG timer 11 has been started, the timing value of the CG timer 11 is not zero. For example, the timing value of the CG timer 11 is 10 ms, and the count value of the CG counter 12 is two. The CG weight is calculated by the following formula:

$$W = a \times timer + b \times counter = 0.7 \times \frac{10}{200} + 0.3 \times \frac{2}{10} = 0.095 ;$$

Since 0.095<0.7, the CG weight is still smaller than the CG threshold. Therefore, the UE 10 transmits a third new data to the gNB 20.

After a while, the gNB 20 has not continuously and unsuccessfully received the multiple new data. The failed transmission count value of the failed transmission counter 13 is not greater than the failed transmission threshold, the timing value of the CG timer 11 would not be reset, and it means that the CG timer 11 does not stop timing. When the UE 10 determines that the gNB 20 successfully receives the new data, the UE 10 calculates the CG weight again. For example, the timing value of the CG timer 11 is 180 ms, and the count value of the CG counter 12 is three. The CG weight is calculated by the following formula:

$$W = a \times timer + b \times counter = 0.7 \times \frac{180}{200} + 0.3 \times \frac{3}{10} = 0.72 ;$$

Since 0.72≥0.7, the CG weight is greater than the CG threshold. Therefore, the UE 10 switches to the first CG transmission mode.

Moreover, the gNB 20 may partially unsuccessfully receive the multiple new data. If a number of the gNB 20 continuously and unsuccessfully receiving the multiple new data is not greater than the failed transmission threshold, the UE 10 resets the CG counter 12 but does not reset the CG timer 11. Even if the count value of the CG counter 12 is reset, the CG timer 11 will does not stop timing. When the timing value of the CG timer 11 (timer_current) reaches the preset maximum of waiting time (timer_max), the CG weight is calculated by the following formula:

$$W = a \times timer + b \times counter = 0.7 \times \frac{200}{200} + 0.3 \times \frac{0}{10} = 0.7 ;$$

Since 0.7≥0.7, the CG weight is greater than the CG threshold. Therefore, the UE 10 switches to the first CG transmission mode. Namely, even if the count value of the CG counter 12 is reset, the UE 10 can switch to the first CG transmission mode when the timing value of the CG timer 11 reaches the preset maximum of waiting time.

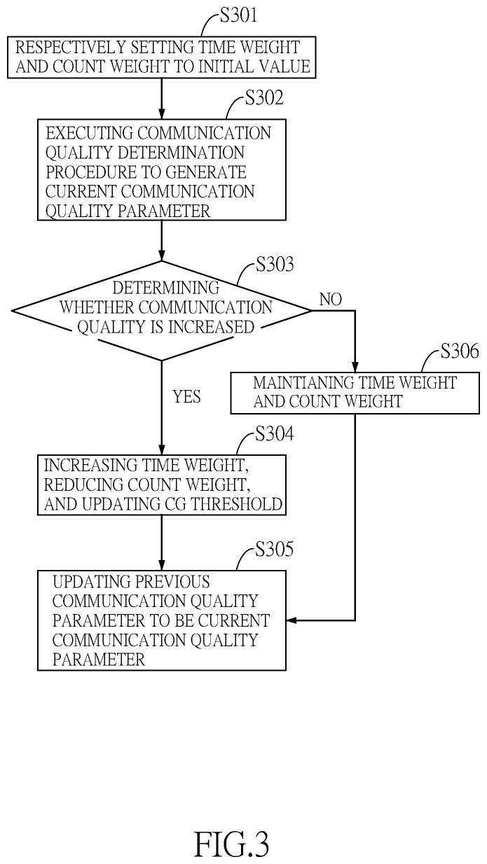

With reference to FIG. 3, the method for dynamically switching transmission modes in UCEs further includes step S301 to step S306.

In steps S301, the UE 10 respectively sets the time weight a and the count weight b to an initial value, and presets a previous communication quality parameter.

In step S302, the UE 10 executes a communication quality determination procedure to generate a current communication quality parameter.

In step S303, the UE 10 determines whether communication quality is increased according to the previous communication quality parameter and the current communication quality parameter for adjusting the time weight a and the count weight b. In the embodiment, a sum of the time weight a and the count weight b is 1.

In step S304, when the communication quality is increased, the UE 10 increases the time weight a and reduces the count weight b.

In step S305, the UE 10 updates the previous communication quality parameter to be the current communication quality parameter.

In step S306, when the communication quality is not increased, the UE 10 maintains the time weight a and the count weight b, and updates the previous communication quality parameter to be the current communication quality parameter.

The UE 10 can determine the communication quality of the radio channels becoming better or worse according to the communication quality determination procedure. Then, the UE 10 can dynamically adjust the time weight a and the count weight b according to the communication quality. Namely, the CG weight is calculated corresponding to the communication quality. When the communication quality is changed, the time weight a and the count weight b are correspondingly changed. Further, the UE 10 can calculate the CG weight only based on the time weight a or the count weight b. Namely, the UE 10 can set the time weight a to be one, and set the count weight b to be zero. Or the UE can set the time weight a to be zero, and set the count weight b to be one.

For example, the initial value of the time weight a is 0.5, and the initial value of the count weight b is 0.5. Namely, a=0.5, b=0.5, TH=0.5, timer_max=200 ms, counter_max=10. Further, the timing value of the CG timer 11 is 100 ms, and the count value of the CG counter 12 is three. When the UE 10 determines that the gNB 20 successfully receives the new data, the UE 10 calculates the CG weight according to the following formula:

$$W = a \times timer + b \times counter = 0.5 \times \frac{100}{200} + 0.5 \times \frac{3}{10} = 0.4$$

Since 0.4<0.7, the CG weight is smaller than the CG threshold. Therefore, the UE 10 transmits a next new data to the gNB 20.

After a while, the UE 10 executes a communication quality determination procedure to determine whether the communication quality of the radio channels is increased. When the communication quality of the radio channels is increased, the UE 10 increases the time weight a, reduces the count weight b, and further updates the CG threshold.

For example, after the UE 10 increases the time weight a and reduces the count weight b, the time weight a is 0.7, the count weight b is 0.3, and the CG threshold TH is 0.7. Further, timer_max=200 ms, counter_max=10. At this time, the timing value of the CG timer 11 is 180 ms, and the count value of the CG counter 12 is three. When the UE 10 determines that the gNB 20 successfully receives the new data, the UE 10 calculates the CG weight according to the following formula:

$$W = a \times timer + b \times counter = 0.7 \times \frac{180}{200} + 0.3 \times \frac{3}{10} = 0.72$$

Since 0.72≥0.7, the CG weight is greater than the CG threshold. Therefore, the UE 10 switches to the first CG transmission mode.

When the communication quality is increased, it means that the communication quality is stable. Therefore, the UE 10 increases the time weight a, and reduces the count weight b. Thereby, the influence of the timing value of the CG timer 11 can be increased by increasing the time weight a when the UE 10 calculates the CG weight.

In the embodiment, the communication quality determination procedure is executed periodically.

In another embodiment, the communication quality determination procedure is executed when the UE 10 switches to the first CG transmission mode.

In addition, the UE 10 can also execute the communication quality determination procedure in real time according to the communication quality for updating the time weight a, the count weight b, and the CG threshold TH in real time.

The UE 10 can determine whether the communication quality is increased by measuring the signal strength of communication signals. For example, the previous communication quality parameter is a strength value of a first communication signal received at the beginning. The current communication quality parameter is a strength value of a communication signal received when the communication quality determination procedure is executed. If the previous communication quality parameter is smaller than or equal to the current communication quality parameter, it means that the signal strength of the communication signals is increased, so that the UE 10 can determine that the communication quality is increased.

Furthermore, the UE 10 may also measure an error rate, a failure rate, or a retransmission rate of transmitting the new data to the gNB 20 to determine whether the communication quality is increased. For example, when the error rate, the failure rate, or the retransmission rate is uncreased, the UE 10 determines that the communication quality is increased.

Moreover, the UE 10 can determine whether the communication quality is increased by measuring the delay time of transmitting the new data to the gNB 20. For example, when the delay time becomes shorter, the UE 10 determines that the communication quality is increased.

Alternatively, the UE 10 can determine whether the communication quality is increased by measuring a switching frequency of switching the CG transmission modes. For example, when the switching frequency becomes lower, the UE 10 determines that the communication quality is increased.

In summary, the UE 10 can count the number of UE successful transmissions, or a number of gNB successful receptions by the CG counter 12. Thereby, the communication quality of the radio channels can be determined, the UE 10 can decrease latency by switching to the first CG transmission mode for improving a utilization rate of resources and getting better performance.

Even though numerous characteristics and advantages of the present disclosure have been set forth in the foregoing description, together with details of the structure and features of the disclosure, the disclosure is illustrative only. Changes may be made in the details, especially in matters of shape, size, and arrangement of parts within the principles of the disclosure to the full extent indicated by the broad general meaning of the terms in which the appended claims are expressed.

What is claimed is:

1. A method for dynamically switching transmission modes in unlicensed spectrum control environments (UCEs), executed by a user equipment (UE); wherein the method comprises steps of:
transmitting a new data to a next generation Node B (gNB);
determining whether the gNB successfully receives the new data;
when the gNB successfully receives the new data, starting a configured grant (CG) timer, increasing a count value of a CG counter, resetting a failed transmission count value of a failed transmission counter, calculating a CG weight according to a timing value of the CG timer and the count value of the CG counter, and determining whether the CG weight is greater than or equal to a CG threshold;
when the CG weight is greater than or equal to the CG threshold, switching to a first CG transmission mode;
when the CG weight is smaller than the CG threshold, transmitting a next new data to the gNB;
wherein the CG weight is calculated by the following formula:
$$W = a \times timer + b \times counter ;$$
$$timer = \frac{timer\_current}{timer\_max} ;$$
$$counter = \frac{counter\_current}{counter\_max} ;$$
wherein W is the CG weight, a is a time weight, b is a count weight, timer_current is the timing value, timer_max is a preset maximum of waiting time, counter_current is the count value, counter_max is a maximum number of preset allowable success, and a+b=1;
wherein the CG threshold is calculated by the following formula:
TH=MAX[a,b];
wherein TH is the CG threshold.

2. The method for dynamically switching the transmission modes in the UCEs as claimed in claim 1, further comprising steps of:
when the gNB unsuccessfully receives the new data, resetting the CG counter, increasing the failed transmission count value, and determining whether the failed transmission count value is greater than or equal to a failed transmission threshold;
when the failed transmission count value is greater than or equal to the failed transmission threshold, resetting the timing value of the CG timer and the failed transmission count value of the failed transmission counter, and transmitting a next new data to the gNB; and
when the failed transmission count value is smaller than the failed transmission threshold, transmitting the next new data to the gNB.

3. The method for dynamically switching the transmission modes in the UCEs as claimed in claim 1, wherein whether the gNB successfully receives the new data is determined by sub steps of:
determining whether an acknowledgement (ACK) signal transmitted by the gNB is received; and
when the ACK signal transmitted by the gNB is received, determining that the gNB successfully receives the new data.

4. The method for dynamically switching the transmission modes in the UCEs as claimed in claim 1, wherein whether the gNB successfully receives the new data is determined by sub steps of:
determining whether a negative-acknowledgement (NACK) signal transmitted by the gNB is received;
when the NACK signal transmitted by the gNB is received, determining that the gNB unsuccessfully receives the new data.

5. The method for dynamically switching the transmission modes in the UCEs as claimed in claim 1, wherein whether the gNB successfully receives the new data is determined by sub steps of:
determining whether a CG retransmission timer expires; and
when the CG retransmission timer expires, determining that the gNB unsuccessfully receives the new data.

6. The method for dynamically switching the transmission modes in the UCEs as claimed in claim 1, further comprising steps of:
respectively setting the time weight a and the count weight b to an initial value, and presetting a previous communication quality parameter;
executing a communication quality determination procedure to generate a current communication quality parameter, and determining whether communication quality is increased according to the previous communication quality parameter and the current communication quality parameter for adjusting the time weight a and the count weight b; wherein a sum of the time weight a and the count weight b is 1;
when the communication quality is increased, increasing the time weight a, reducing the count weight b, and updating the previous communication quality parameter to be the current communication quality parameter; and
when the communication quality is uncreased, maintaining the time weight a and the count weight b, and updating the previous communication quality parameter to be the current communication quality parameter.

7. The method for dynamically switching the transmission modes in the UCEs as claimed in claim 6, wherein the communication quality determination procedure is executed periodically.

8. The method for dynamically switching the transmission modes in the UCEs as claimed in claim 6, wherein the communication quality determination procedure is executed when the UE switches to the first CG transmission mode.

9. A system for dynamically switching transmission modes in unlicensed spectrum control environments (UCEs), comprising:
a user equipment (UE), communicatively connected to a next generation Node B (gNB); wherein the UE is configured to:
transmit a new data to the gNB, and determine whether the gNB successfully receives the new data;
when the gNB successfully receives the new data, start a CG timer, increase a count value of a CG counter, reset a failed transmission count value of a failed transmission counter, calculate a CG weight according to a timing value of the CG timer and the count value of the CG counter, and determine whether the CG weight is greater than or equal to a CG threshold;
when the CG weight is greater than or equal to the CG threshold, switch to the first CG transmission mode;
when the CG weight is smaller than the CG threshold, transmit a next new data to the gNB;
wherein the CG weight is calculated by the following formula:
$$W = a \times timer + b \times counter ;$$
$$timer = \frac{timer\_current}{timer\_max} ;$$
$$counter = \frac{counter\_current}{counter\_max} ;$$
wherein W is the CG weight, a is a time weight, b is a count weight, timer_current is the timing value, timer_max is a preset maximum of waiting time, counter_current is the count value, counter_max is a maximum number of preset allowable success, and a+b=1;
wherein the CG threshold is calculated by the following formula:
TH=MAX[a,b];
wherein TH is the CG threshold.

10. The system for dynamically switching the transmission modes in the UCEs as claimed in claim 9, wherein when the gNB unsuccessfully receives the new data, the UE resets the CG counter, increases the failed transmission count value, and determines whether the failed transmission count value is greater than or equal to a failed transmission threshold;
wherein when the failed transmission count value is greater than or equal to the failed transmission threshold, the UE resets the timing value of the CG timer and the failed transmission count value of the failed transmission counter, and transmits a next new data to the gNB;
wherein when the failed transmission count value is smaller than the failed transmission threshold, the UE transmits the next new data to the gNB.

11. The system for dynamically switching the transmission modes in the UCEs as claimed in claim 9, wherein the UE determines whether the gNB successfully receives the new data is determined by determining whether an acknowledgement (ACK) signal transmitted by the gNB is received;
when the ACK signal transmitted by the gNB is received, the UE determines that the gNB successfully receives the new data.

12. The system for dynamically switching the transmission modes in the UCEs as claimed in claim 9, wherein the UE determines whether the gNB successfully receives the new data by determining whether a negative-acknowledgement (NACK) signal transmitted by the gNB is received; and
when the NACK signal transmitted by the gNB is received, the UE determines that the gNB unsuccessfully receives the new data.

13. The system for dynamically switching the transmission modes in the UCEs as claimed in claim 9, wherein the UE determines whether the gNB successfully receives the new data by determining whether a CG retransmission timer expires; and
when the CG retransmission timer expires, the UE determines that the gNB unsuccessfully receives the new data.

14. The system for dynamically switching the transmission modes in the UCEs as claimed in claim 9, wherein the UE respectively sets the time weight a and the count weight b to an initial value, and presets a previous communication quality parameter;
wherein the UE executes a communication quality determination procedure to generate a current communication quality parameter, and determines whether communication quality is increased according to the previous communication quality parameter and the current communication quality parameter for adjusting the time weight a and the count weight b; wherein a sum of the time weight a and the count weight b is 1;
wherein when the communication quality is increased, the UE increases the time weight a, reduces the count weight b, and updates the previous communication quality parameter to be the current communication quality parameter;
wherein when the communication quality is reduced, the UE maintains the time weight a and the count weight b, and updates the previous communication quality parameter to be the current communication quality parameter.

15. The system for dynamically switching the transmission modes in the UCEs as claimed in claim 14, wherein the communication quality determination procedure is executed periodically by the UE.

16. The system for dynamically switching the transmission modes in the UCEs as claimed in claim 14, wherein the communication quality determination procedure is executed when the UE switches to perform the first CG transmission mode.
